(19) United States
(12) Patent Application Publication
(10) Pub. No.: US 2018/0314408 A1
(43) Pub. Date: Nov. 1, 2018

(54) SYSTEMS AND METHODS FOR MANAGING VIEWS OF COMPUTER-AIDED DESIGN MODELS

(71) Applicant: General Electric Company, Schenectady, NY (US)

(72) Inventors: Jason Anton Byers, Greenville, SC (US); Alexandria Stoker Cochrane, Greenville, SC (US); Brian Christopher Wheeler, Simpsonville, SC (US); Jeffrey David Erno, Simpsonville, SC (US)

(21) Appl. No.: 15/582,505

(22) Filed: Apr. 28, 2017

(51) Int. Cl. G06F 3/0484; G06T 11/20; G06F 3/0482; G06F 17/50

(52) U.S. Cl. CPC G06F 3/04845; G06T 11/206; G06F 17/5009; G06F 3/0482; G06F 3/04847

(57) ABSTRACT

A tangible, non-transitory, machine-readable medium comprising instructions configured to cause a processor to access data related to one or more views of a computer-aided design (CAD) model. The instructions are also configured to cause the processor to derive a graph based on the accessed data. The graph includes one or more graph elements. Additionally, the instructions are also configured to cause the processor to receive user input indicative of a request to manipulate a graph element of the one or more graph elements and derive a new view of the CAD model based on the user input.

### BACKGROUND OF THE INVENTION

The subject matter disclosed herein relates to systems and methods for managing views of models, such a computer-aided models, that may be used in the design and inspection of parts, such as industrial machine parts.

Industrial machines, such as gas turbine systems, may provide for the generation of power. For example, the gas turbine systems typically include a compressor for compressing a working fluid, such as air, a combustor for combusting the compressed working fluid with fuel, and a turbine for turning the combusted fluid into a rotative power. For example, the compressed air is injected into a combustor, which heats the fluid causing it to expand, and the expanded fluid is forced through the gas turbine. The gas turbine may then convert the expanded fluid into rotative power, for example, by a series of blade stages. The rotative power may then be used to drive a load, which may include an electrical generator producing electrical power and electrically coupled to a power distribution grid. Industrial machines and machine parts may be designed for a particular purpose, such as a compressor blade designed to compress air. Various views associated with models of the of industrial machines and machine parts may be generated while designing the industrial machines and machine parts.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a tangible, non-transitory, machine-readable medium comprising instructions configured to cause a processor to access data related to one or more views of a computer-aided design (CAD) model. The instructions are also configured to cause the processor to derive a graph based on the accessed data. The graph includes one or more graph elements. Additionally, the instructions are also configured to cause the processor to receive user input indicative of a request to manipulate a graph element of the one or more graph elements and derive a new view of the CAD model based on the user input.

In a second embodiment, a system includes a processor configured to access data related to one or more of views of a computer-aided design (CAD) model. The processor is also configured to derive a graph based on the accessed data. The graph includes one or more graph elements. Additionally, the processor is configured to receive user input indicative of a request to manipulate a graph element of the one or more graph elements and derive a new view of the CAD model based on the received user input.

In a third embodiment, a method includes accessing, via a processor, data related to one or more views of a computer-aided design (CAD) model. The method also includes deriving, via the processor, a graph based on the accessed data. The graph includes one or more graph elements. Additionally, the method includes receiving, via the processor, user input indicative of a request to manipulate a first graph element of the one or more graph elements and deriving, via the processor, a new view of the CAD model based on the received user input.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a computer-aided technology (CAx) system, in accordance with embodiments described herein;

FIG. 2 is a block diagram of a certain components of the CAx system of FIG. 1, in accordance with embodiments described herein;

FIG. 3 is a block diagram of an industrial system that may be conceived, designed, engineered, manufactured, and/or service and tracked by the CAx system of FIG. 1, in accordance with embodiments described herein;

FIG. 4 is a diagram of a graphical display as well as a processor-executable application that may be used to manage views of the model, in accordance with embodiments described herein; and

FIG. 5 is a flow chart of a method for managing views, in accordance with embodiments described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a part design. For example, the part design may be created as a model-based definition included in a 3dimensional (3D) computer aided design (CAD) model. The techniques described herein may not create typical engineering part drawing or drawings, as the CAD model may contain all part dimensional and tolerance information.

During the creation, design, and/or modification, of a CAD model, a user may generate one or more views of the model, such as graphical 2-dimensional views. A view managing application may enable the views to be displayed and managed by users within a view managing system, such as a processor-executable software system. For instance, views may be displayed as a list in alphanumeric order, the user may enter an input indicative of a request to change the order of the views in the list, and the view managing application may complete the requested change and redisplay the list. The view managing system may reflect the change in the order of the views. Moreover, names of the views may be changed and/or updated either by user input or as a result of executing user input associated with another view. For example, if the order of a view is changed, the name of the view may be updated to reflect the new position of the view in the list of views. Further, views may include nested views, such as tree of views or other graph-like display of views. The user may more easily manipulate relationship between views, such as grandparent-parent-child relationships, using the techniques described herein.

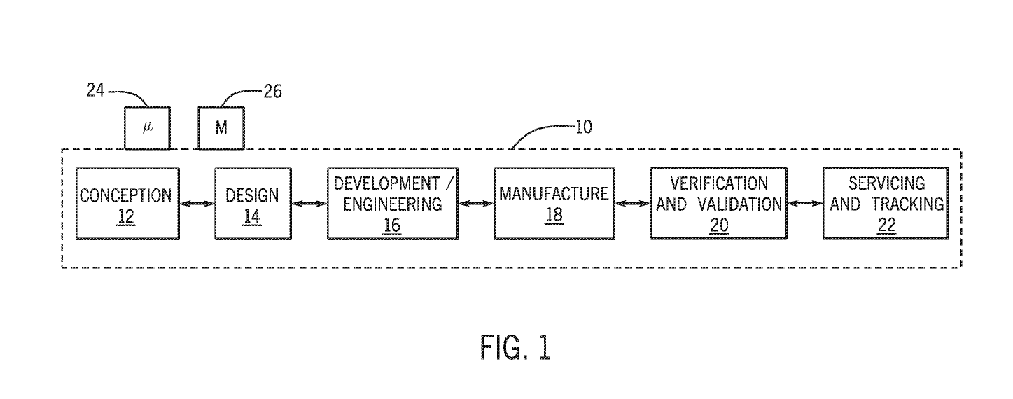

With the foregoing in mind, it may be useful to describe a computer-aided technologies (CAx) system that may incorporate the techniques described herein, for example to improve product lifecycle management (PLM) processes. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machine). A series of design processes 14 may then use the specifications and/or prototype to produce, for example, one or more 3D design models of the part or product. The 3D design models may include solid/surface modeling, parametric models, wireframe models, vector models, non-uniform rational basis spline (NURBS) models, geometric models, and the like. Additionally, the 3D design models may include views, and, as described in detail below, a view managing system may be used to manage the views and view relationships.

Design models may then be further refined and added to via the execution of development/engineering processes 16. The development/engineering processes may, for example, create and apply models such as thermodynamic models, low cycle fatigue (LCF) life prediction models, multibody dynamics (MBD) and kinematics models, computational fluid dynamics (CFD) models, finite element analysis (FEA) models, and/or 3dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in tolerances, materials specifications (e.g., material type, material hardness), clearance specifications, and the like.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. By automatically calibrating machine settings and/or the producibility advisor system, the part may be manufactured more efficiently and accurately.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be used by any other of the processes 12, 14, 16, 18, 20, 22 to improve the part or product or to create a new part or a new product. In this manner, the CAx system 10 may incorporate data from downstream processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

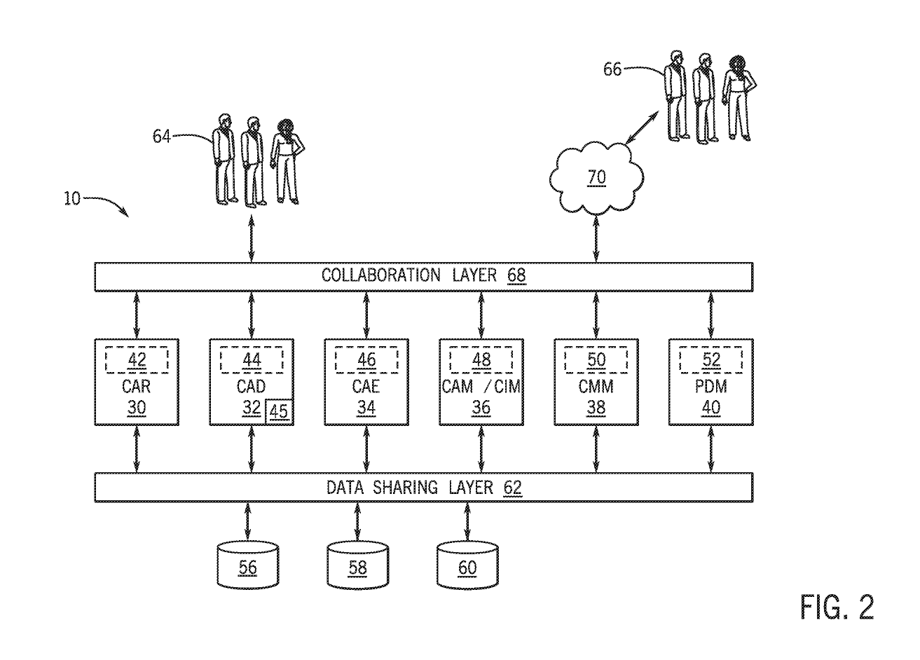

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40. Each of the systems 30, 32, 34, 36, 38 and 40 may be extensible and/or customizable; accordingly, each system 30 may include an extensibility and customization system 42, 44, 46, 48, 50, and 52, respectively. Additionally, each of the systems 30, 32, 34, 36, 38 and 40 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, and so on). Indeed, the CAD system 32 may combine a graphical representation of the part or product with other, related information. The CAD system 32 may also provide for the creation and management of views within the 2D and/or 3D models. The CAD system 32 may include a view managing system 45 that, when executed by the processor 24, may graphically display the views a user has created as well as how the views are related to another view of the 2D and 3D models. Moreover, as discussed below, the view managing system 45 may allow a user to change the name of a view and/or the order in which views are listed and update the names and/or order the views are listed.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics (MBD) and kinematics models, computational fluid dynamics (CFD) models, finite element analysis (FEA) models, and/or 3dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, 38, and/or 40. For example, the systems 30, 32, 34, 36, 38, and/or 40 may communicate with data repositories 56, 58, 60 via a data sharing layer 62. The PDM system 40 may then manage collaboration between the systems 30, 32, 34, 36, 38 and/or 40 by providing for data translation services, versioning support, archive management, notices of updates, and so on. The PDM system 40 may additionally provide for business support such as interfacing with supplier/vendor systems and/or logistics systems for purchasing, invoicing, order tracking, and so on. The PDM system 40 may also interface with service/logging systems (e.g., service center data management systems) to aid in tracking the maintenance and life cycle of the part or product as it undergoes operations. Teams 64, 66 may collaborate with team members via a collaboration layer 68. The collaboration layer may include web interfaces, messaging systems, file drop/pickup systems, and the like, suitable for sharing information and a variety of data. The collaboration layer 68 may also include cloud-based systems 70 or communicate with the cloud-based systems 70 that may provide for decentralized computing services and file storage. For example, portions (or all) of the systems 30, 32, 34, 36, 38 may be stored in the cloud 70 and/or accessible via the cloud 70.

The extensibility and customization systems 42, 44, 46, 48, 50, and 52 may provide for functionality not found natively in the CAR system 30, the CAD system 32, the CAM/CIM system 36, the CMM system 38 and/or the PDM system 40. For example, computer code or instructions may be added to the systems 30, 32, 34, 36, and/or 38 via shared libraries, modules, software subsystems and the like, included in the extensibility and customization systems 42, 44, 46, 48, 50, and/or 52. The extensibility and customization systems 42, 44, 46, 48, 50, and 52 may also use application programming interfaces (APIs) included in their respective systems 30, 32, 34, 36, and 38 to execute certain functions, objects, shared data, software systems, and so on, useful in extending the capabilities of the CAR system 30, the CAD system 32, the CAM/CIM system 36, the CMM system 38 and/or the PDM system 40. By enabling the processes 12, 14, 16, 18, 20, and 22, for example, via the systems 30, 32, 34, 36, and 38 and their respective extensibility and customization systems 42, 44, 46, 48, 50, and 52, the techniques described herein may provide for a more efficient “cradle-to-grave” product lifecycle management.

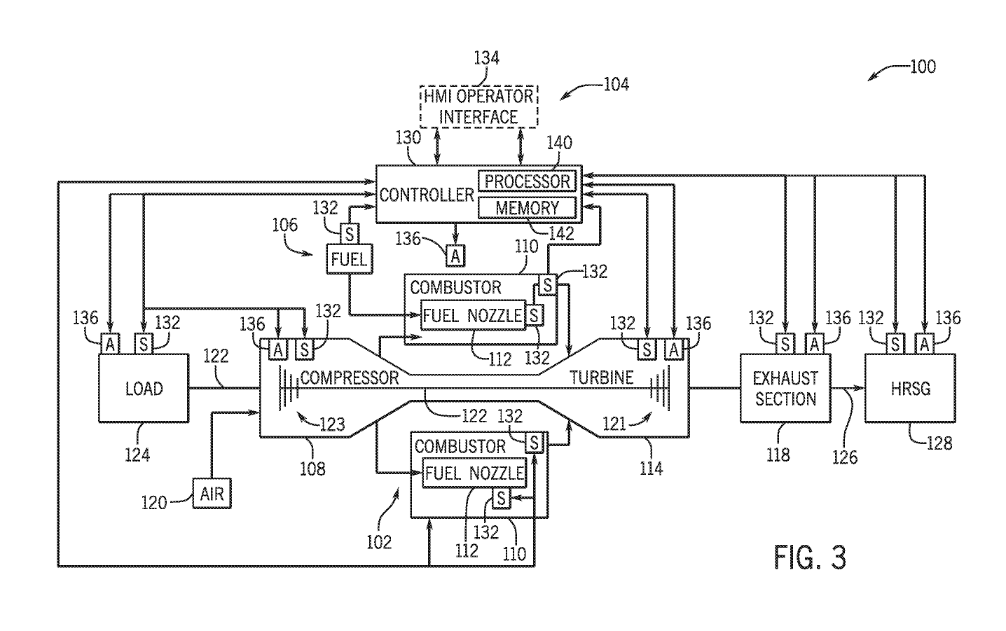

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 1, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades, which may in turn drive rotation of a shaft 122. The shaft 122 may connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power plant 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the system 100 may also include a controller 130. The controller 130 may be communicatively coupled to a number of sensors 132, a human machine interface (HMI) operator interface 134, and one or more actuators 136 suitable for controlling components of the system 100. The actuators 136 may include valves, switches, positioners, pumps, and the like, suitable for controlling the various components of the system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the system 100. A plant operator may interface with the industrial system 10 via the HMI operator interface 44. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

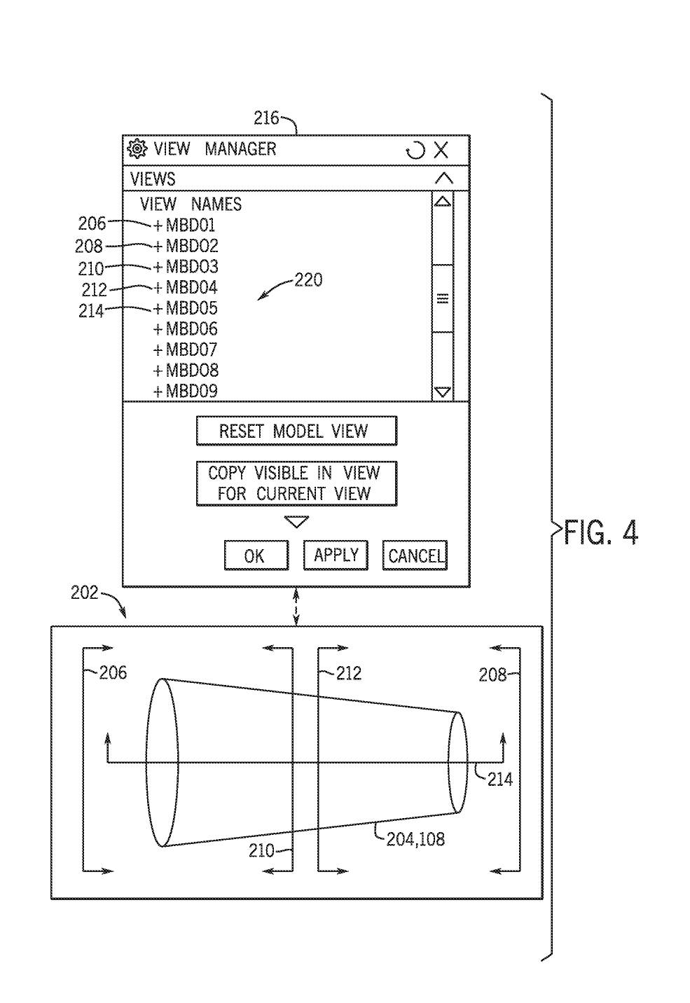

Components of the power generation system 100 may be designed and/or modeled using the CAD system 32 as part of the design processes 14. During the design processes 14 or other PLM processes such as, but not limited to, the development/engineering processes 16 and the manufacturing processes 18, users may generate views of models and manage the generated views, for example, via the view managing system 45. With this in mind, FIG. 4 illustrates an embodiment of a graphical display 202 as well as a graphical user interface (GUI) 216 included in the view managing system 45 that may be used to manage views displayed via the graphical display 202, for example of a CAD model 204. The CAD model 204 may be generated by the processors 24 to be displayed on the display 202 based on updated, for example, derived by via the view managing system 45 included in the CAD system 32. It is to be understood that any other suitable processor or processors may be used to execute the view managing system 45, and that the view managing system 45 may be implemented as computer instructions or code separate from the CAD system 32 or included in the CAD system 32.

In the depicted embodiment, the graphical display 202 shows the CAD model 204 as including a component of the gas turbine system 102. More specifically, in the illustrated embodiment, the CAD model 204 is a 3D model of the compressor 108. The graphical display 202 may include several views 206, 208, 210, 212, 214 suitable for viewing different portions and/or perspectives of the compressor 108, and the user may select (e.g., by clicking with a computer mouse or by touching if using a touch screen) one of the views 206, 208, 210, 212, 214 to display the selected view. The selected view may include a 2D or 3D representation of a portion of the 3D model. For instance, the selected view may be a perspective view of the 3D model or a portion thereof, a cross-sectional view of the model or a portion thereof, or a top, bottom, or side view of the 3D model. Each of the views 206, 208, 210, 212, 214 is shown as it relates to the present view shown on the graphical display 202 in FIG. 4. For instance, the views 210, 212 are cross-sectional views of the CAD model 204 while views 206 and 208 are side views of the CAD model 204.

The CAD model 204 of the compressor 108 and the views 206, 208, 210, 212, 214 may be referenced by or include certain programming objects. The programming objects may include attributes or properties that define characteristics of the objects. For example, a programming object for one of the views 206, 208, 210, 212, 214 may include an attribute that defines the type of view or the relationship of the view relative to the model (e.g., a cross-sectional view, a perspective view, a top-down view etc.) Another example attribute may include a name. Yet other example attributes may include view size, view location, view geometry (e.g., square geometry, circular geometry), view default fonts, font styles, color, and so on. That is, the programming objects may include attributes that, among other definitions, also define names for the programming objects or the models or views to which the programming objects relate.

The views 206, 208, 210, 212, 214 may be displayed and/or listed in the GUI 216. As illustrated, the views 206, 208, 210, 212, 214 are listed in alphanumeric order, although in other embodiments, the views may be displayed in a different order (e.g., by type of view, by view size, by view location, and so on). In one embodiment, the GUI 216 displays a tree structure display. A tree structure is a data structure that may be used to display a hierarchical relationship that exists between two or more data. For example, a tree structure may be used to organize and aid in defining the relationship one view may have to another view. As a more specific example, a tree structure may be used to denote that one view is derived from another view and vice versa. In other words, a tree structure may be utilized to define a parent-child relationship between two views. A parent may have multiple children. For instance, there may be three views of the model 204: a general view (e.g., parent view), a first child view that is zoom-in view of a portion of the general view, and a second child view that is a cross-sectional view of another portion of the general view. Each child view could in turn have multiple children, thus defining a tree with a root view. In the depicted embodiment, views 206, 208, 210, 212, 214 are root views, and by clicking on a ‘+’ icon the GUI 216 may then display respective children of each root view. Tree structures and data associated with the tree structures may be stored on the memory 26 and/or the cloud 70.

As the user adds and/or deletes views, the GUI 216 may update a list 220 of views to reflect that a view has been added or deleted. Moreover, the GUI 216 may automatically recognize the relationship of the added or deleted view and other views and then reflect such a relationship in the display of the list 220. As such, the list 220 of views, which includes a graphical representation of the tree structure, may be updated to reflect how the added or deleted view relates to other views. For example, a user may generate a new view that is derived from another view (e.g., view 206). That the new view was derived from the other view may be recognized by the view managing system 45 and reflected in the GUI 216, for example, by clicking on the ‘+’ icon beside the view 206 so that the new view that was created will now show up in the list 220 when the ‘+’ icon is clicked.

The graphical representations of the tree structures may be expanded and collapsed based on received user input. For example, the user may select the ‘+’ icon next to one of the views in the list 220 of views, and the views derived from that selected view may be displayed within the GUI 216. Additionally, derived views that have children may also be associated with the ‘+’ icon so that the user may select the children in order to expand and/or collapse views derived from the derived view.

The user may also modify the views that are listed within the GUI 216. For example, the user may select a view from the list 220 of views in the GUI tool 216, drag the view, and drop the view to a different location within the list 220 of views. The view may then be updated in a number of ways. First, the name of the view may be changed to reflect the changed location within the list of views. For example, a view with a name reflecting that it was the third view may have been moved to the fifth spot in the list, and the view's name may be updated to reflect that is was moved to the fifth position in the list. Additionally, all of the other views may be updated to reflect the switch in positions of views in the list. Continuing with the same example, the view that was previously fourth may become the third view, and the view that was previously fifth may become the fourth view. In other words, when user input indicating that a change to a view be made is received, the view managing system 45 may determine how to implement the requested change and then carry out the changes in a breadth first and/or depth first matter. For example, upon receiving user input indicative of a request to change the position of a view within the list 220 of views, the view managing system 45 may determine how to implement the requested change.

More specifically, upon receiving user input indicative of a request to change to the list 220 of views, the programming objects associated with each of the views may be updated. For example, one of the attributes associated with a view may define the name of the view, while another attribute may define the position of the view within the list 220 of views. When the user makes an input indicative of a request to change the position of a view within the list 220 of views, the attributes of the programming objects associated with the view as well as the attributes of the programming objects associated with the other views of the list 220 may be updated to reflect the user input. For instance, an attribute reflecting the name of a view with which the attribute is associated may be changed to reflect a different name for the view (e.g., MBD04 to MBD05). Similarly, an attribute reflecting the position of the view with which the attribute is associated may be changed to reflect a different position of the view in the list 220 of views of the GUI 216.

In other words, when user input indicative of a request to change a view is received (e.g., a user moved the name of the view in the list 220 to another location in the list 220), the view managing system 45 may make changes to the attributes of the programming objects associated with the view in order to implement that requested change. Furthermore, the attributes of the programming objects associated with other views may be changed based on the changes implemented to programming objects associated with one view due to the user input. For example, attributes of programming objects reflecting the names of the programming objects may be changed based on the received user input. As a more specific example, for user input indicating a request to change the third view (“MBD03”) to the fifth position, the view may be changed from “MBD03” to “MBD05” (via a change made to one or more attributes or a programming object associated with the view) and as a result of this change, attributes of programming objects associated with other views may be modified. For instance, an attribute associated with a view previously named “MBD04” may be edited so that the attribute reflects that the name of the view is changed to “MBD03.”

Moreover, if a view has been derived from another view, the programming objects of the derived view may also be edited based on user input that would cause the view managing system 45 to edit programming objects of the view from which the derived view was derived. In other words, not only may attributes of programming objects associated with one view be edited based on user input, but the attributes of the programming objects of views (e.g., child views) derived from the view may also be edited. For example, if user input causes the order of the list 220 of views in the GUI 216 to be modified, the order or any view derived from another view may also be modified based on the modified position of the view from which the other view was is derived. That is, while the position of a view may change within the list 220 of views of the GUI 216, the views that are derived from the view (e.g., views visible upon selecting the plus sign), may still be associated with the view (e.g., in the list of views of the view managing application tool 216).

It should be noted that upon receiving user input, the requested changes indicated by the user input may be implemented automatically by the view managing system 45. For example, the processors 24, in executing the view managing system 45 may automatically determine how to implement the user input and carry out the determined manner of implementing the user input (e.g., by editing programming objects associated with one or more views, redisplaying an updated list 220, and so on).

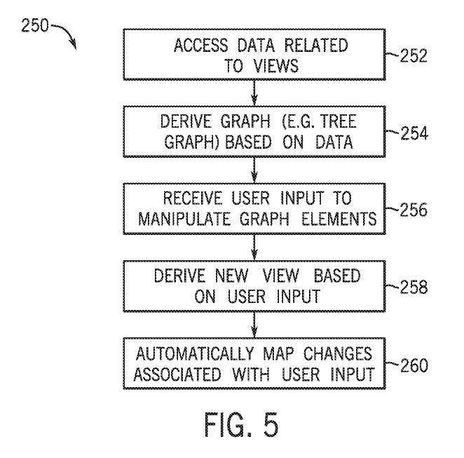

Keeping the discussion of FIG. 4 in mind, FIG. 5 is a flow chart of an embodiment of a process 250 for managing views. The process 250 may be implemented as computer code or instructions included the view managing system 45, stored in the memory 26 and executed, for example, by the processors 24. However, it should also be noted that any suitable processor or application may execute the process 250. Moreover, while the process 250 is described using steps in a specific sequence, it should be understood that the present disclosure contemplates that the describe steps may be performed in different sequences than the sequence illustrated, and certain described steps may be skipped or not performed altogether.

At block 252, the process 250 may access data related to views. The data may be stored on the memory 26, the network 70, or another suitable location. The data related to the views may include, but is not limited to data associated with CAD models, such as programming objects and/or attributes of the programming objects.

At block 254, the process 250 may derive one or more graphs based on the accessed data. For example, the graphs may include graph elements, such as graphical representations of the tree structures and the names of views. However, the views may be related in any type of graph structure, including simple graphs, undirected graphs, directed graphs, cyclic graphs, directed acyclic graphs, and so on. In one embodiment, the process 250 may determine the relationship between programming objects associated with a 3D model and generate a tree structure. The process 250 may also generate a graphical representation of the tree structure (e.g., the list of views shown in the view managing application tool 216).

At block 256, the process 250 may receive user input to manipulate graph elements. For instance, as discussed above, a user may make an input indicating that the order of views be changed. As another example, a user may change the name of a view.

At block 258, the process 250 may derive a new view based on the user input. More specifically, as discussed above, the process 250 may determine how to implement the received user input. For instance, if the user input is indicative of a request to change the order in which views are listed in the list of views of the view managing application tool 216, the process 250 may determine how to carry such a request. For instance, the process 250 may determine how to edit attributes associated with the order and/or name of views in order to fulfill the request.

At block 260, the process 250 may automatically map changes associated with the user input. In other words, the process 250 may implement the means of carrying out the user input described in the relation to block 258. In the example of user input that is indicative of a request to change the order in which views are listed in the list 220 of views of the GUI 216, the process 250 may determine how to carry such a request and then execute the determined means to carry out the request. That is, the process 250 may determine how to edit attributes associated with the order and name of programming objects associated with the views in order to fulfill the request, and the process 250 may execute the determined manner to meet the request. Similarly, in the event user input is indicative of request to change the name of a view, such a request may be fulfilled via execution of the view managing system 45, and the names of other views may be changed based on the completed request. For instance, a user may change a number in the name of a view by a certain amount, and the numbers in the names of the other views in the list of views before or after the view may be changed by the same or a different amount in order to complete the requested name change.

Technical effects of the subject matter disclosed herein include, but are not limited to, managing views of the CAD models. In particular, the processors 24 may execute the view managing system 45 and/or the process 250 to edit programming objects associated with the CAD models based on received user input. For instance, various users may edit the CAD model at various stages in the design, engineering, and manufacture of a component associated with a model of the power generation system 100. Users may make inputs indicative of requests to change the names and/or order of views, and the processors 24 may edit the programming objects associated with the views. In this manner, costs associated with editing, designing, and ultimately manufacturing components, such as components of the power generation system 100, may be reduced.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ”, it is intended that such elements are to be interpreted under 35 U.S.C. 112(f). However, for any claims containing elements designated in any other manner, it is intended that such elements are not to be interpreted under 35 U.S.C. 112(f).

1. A tangible, non-transitory, machine-readable medium comprising instructions configured to cause a processor to:
access data related to one or more views of a computer-aided design (CAD) model;
derive a graph based on the accessed data, wherein the graph comprises one or more graph elements;
receive user input indicative of a request to manipulate a graph element of the one or more graph elements; and
derive a new view of the CAD model based on the user input.

2. The tangible, non-transitory, machine-readable medium of claim 1, wherein the data related to the one or more views comprises one or more programming objects, wherein the one or more programming objects each comprise one or more attributes.

3. The tangible, non-transitory, machine-readable medium of claim 2, wherein the one or more attributes each comprise a name of one of the one or more views.

4. The tangible, non-transitory, machine-readable medium of claim 2, wherein the one of more attributes each comprise position data regarding a position of one of the one or more programming objects in a tree structure displayable via a display.

5. The tangible, non-transitory, machine-readable medium of claim 4, wherein the graph comprises a list of the one or more graph elements, wherein the user input is indicative of a request to change a position of one of the graph elements in the list.

6. The tangible, non-transitory, machine-readable medium of claim 5, wherein the user input comprises dragging, via a graphical user interface (GUI), the one of the one or more graph elements and dropping, via the GUI, the one graph element to a different location within the list of graph elements.

7. The tangible, non-transitory, machine-readable medium of claim 1, wherein the one or more graph elements comprise hierarchical representations representative of a relationship between at least two of the views.

8. The tangible, non-transitory, machine-readable medium of claim 1, wherein the instructions cause the processor to automatically map changes associated with the user input, wherein the changes are associated with modifications to an order of the one or more views in the list, to one or more names of the one or more views, or to a combination thereof.

9. A system comprising a processor configured to:
access data related to one or more of views of a computer-aided design (CAD) model;
derive a graph based on the accessed data, wherein the graph comprises one or more graph elements;
receive user input indicative of a request to manipulate a graph element of the one or more graph elements; and
derive a new view of the CAD model based on the received user input.

10. The system of claim 9, wherein the graph comprises a list of the one or more graph elements.

11. The system of claim 9, wherein the data related to the one or more views comprises one or more programming objects, wherein each of the one or more programming objects comprises one or more attributes.

12. The system of claim 11, wherein the one or more graph elements comprise one or more names associated with the one or more of views.

13. The system of claim 12, wherein the user input is indicative of a request to change an order of the one or more names.

14. The system of claim 13, wherein the new view is at least partially derived by modifying at least a first programming object of the one of more programming objects, wherein the first programming object is associated with a first view of the one or more views.

15. A method, comprising:
accessing, via a processor, data related to one or more views of a computer-aided design (CAD) model;
deriving, via the processor, a graph based on the accessed data, wherein the graph comprises one or more graph elements;
receiving, via the processor, user input indicative of a request to manipulate a first graph element of the one or more graph elements; and
deriving, via the processor, a new view of the CAD model based on the received user input.

16. The method of claim 15, wherein the one or more graph elements correspond to one or more names of one or more views of the CAD model.

17. The method of claim 16, wherein the one or more graph elements correspond to a one or more programming objects associated with the one or more views, wherein the one or more programming objects comprise one or more attributes, wherein the one or more attributes comprise data corresponding to the one or more names of the views and one or more positions of the views within a list of the one or more views, wherein the graph comprises the list of the one or more views.

18. The method of claim 17, wherein deriving a new view of the CAD model based on the received user input comprises changing, via the processor, a first attribute of the one or more attributes, wherein the first attribute is associated with a first programming object of the one or more programming objects, wherein the first programming object is associated with a first view of the one or more views, wherein the user input corresponds to a request to manipulate the first graph element, wherein the first graph element corresponds to the first view and is associated with the first programming object.

19. The method of claim 18, wherein deriving a new view of the CAD model based on the received user input comprises changing, via the processor, a second attribute of the one or more attributes, wherein the second attribute is associated with the first programming object, wherein the second attribute comprises data associated with a position of the first view in the list of the plurality of views.

20. The method of claim 19, wherein deriving a new view of the CAD model based on the received user input comprises changing, via the processor, a third attribute of the one or more attributes based on the changes made to the first attribute or second attribute, wherein the third attribute is associated with a second programming object of the one or more programming objects, wherein the second programming object is associated with a second view of the plurality of views.
